(19) United States
(12) Patent Application Publication
(10) Pub. No.: US 2012/0229778 A1
(43) Pub. Date: Sep. 13, 2012

(54) LED PROJECTOR WITH ADJUSTABLE PROJECTING EFFECTS

(76) Inventors: Allan LEE, New Taipei (TW); Ming-Chih HUNG, New Taipei (TW); Ping-Yao CHANG, New Taipei (TW)

(21) Appl. No.: 13/177,224

(22) Filed: Jul. 6, 2011

(30) Foreign Application Priority Data
Mar. 11, 2011 (TW) 100204300

(51) Int. Cl. G03B 21/16; G03B 21/14

(52) U.S. Cl. 353/52; 353/85

(57) ABSTRACT

The present invention relates to a projecting effect adjusting device containing at least a optical module that can change the LED projecting effects. The projecting effect adjusting device has the function of two-dimensional displacement and fixed-point locating using a displacing control module and a locating module. The said two-dimensional displacement allows at least the linear displacement of the projecting effect adjusting device between the first position and the second position. The fixed-point locating allows at least the projecting effect adjusting device to be located on the first position and the second position. The first position is set to keep a distance between the optical module and the LED matrix light source and the second position is set between the optical module and the light-emitting plane of the LED matrix light source.

### BACKGROUND

1. Field of the Invention

The present invention relates to a LED projector. To be more precise, it relates to a LED project with adjustable projecting effects.

2. Description of the Related Art

LED, with its advantage of being environment friendly, energy saving and long duration, is widely used in the file of light source and is used as the light source of products for illumination, warning, signals and monitors. LED light source has its directivity and centrality thus needs various light distribution design to change the projecting effects. The said projecting effects include projecting angle, projecting range and the form of light. In the following patent literature, the relative technology of adjusting the projecting effects of LDC projector is disclosed.

The R.O.C. (Republic of China) Patent No. M372918 on adjustable LED projection lamp concerns the technical characters of adjusting the LED projecting range by adjusting the relative distance between two optical lenses. M372918 is designed to be used as small projecting devices such as pocket lamp or bicycle lighting set and as medium or large projecting devices which require matrix arrangement of LEDs.

The R.O.C. Patent No. 1331633 on illuminator with adjustable light shape concerns the technical characters of a removable second optical module that is linked to the main casing stand which is set on the first optical module relative to the light source. The second optical module can be shifted between the first position and the second position relative to the main casing stand of the light source. When the second optical module is at the first position, the light source penetrates the first optical module and forms the first light shape. When the second optical module is at the second position, the light source penetrates the first and the second modules and forms the second light shape which is different from the first light shape. According to the technical characteristics of the Patent No. 1331633, the second optical module shifts between the first and the second position in a rotary displacing manner and, due to the limit of deflection of the second optical module, the invention of adjustable light shape can be used in simple illuminators which don't have a light source of matrix arrangement.

In the P.R.C. (People's Republic of China) Invention Patent No. CN101187448A on LDC projectors, LED is contained in the case and the emitting plate is fixed on the case and seals the LED in the case. The technical characteristic is that the LED are arranged in camber configuration convex toward the emitting plate to increase the emitting angles of the LED projectors and also the projecting surface of the LED projectors. This Patent No. CN101187448A concerns a technical solution to increase projecting surface of a large LED projector using LED matrix arrangement. However, the technical solution allows the projector to provide a constant projecting surface which is not adjustable according to the needs.

### Summary

The present invention provides the function of adjustable projecting effects to projectors using mainly LED matrix light source. The said projecting effects include but not limited to projecting range, light shape and projecting angles.

To achieve the above-mentioned main technical solution, a projecting effect adjusting device is set in front of the projector. The projecting effect adjusting devices contains at leas a optical module that can change the LED projecting effects. The projecting effect adjusting device has the function of two-dimensional displacement and fixed-point locating using a displacing control module and a locating module. The said two-dimensional displacement allows at least the linear displacement of the projecting effect adjusting device between the first position and the second position. The fixed-point locating allows at least the projecting effect adjusting device to be located on the first position and the second position. The first position is set to keep a distance between the optical module and the LED matrix light source and the second position is set between the optical module and the light-emitting plane of the LED matrix light source.

The outcome of the present invention is that, when the optical module is at the first position, LED light source emits light and form a first projecting effect; when the optical module is at the second position, the LED light source emits light that penetrates the optical module and forms a second projecting effect which is different from the first projecting effect. The optical module can be displaced linearly and set at any location between the first and second position to provide various projecting effects.

### DETAILED DESCRIPTION

For describing the main idea of the present invention as the summary mentioned above, the following preferred embodiment is illustrated. It is necessary to mention that the different elements in the preferred embodiment are drawn for explaining the ratio, size, deformation or displacement and are not drawn proportionally to the real element. Furthermore, similar elements are designated identical number in the following description.

As shown in FIG. 1 to FIG. 3, a projector (10), a projecting effect adjusting device (20), a displacing control module (30) and a locating module (40) are disclosed.

The projector (10) includes several LED (12) arranged in a matrix on a base plate (11). The projecting effect adjusting device (20) includes mainly an optical module (21) and a module unit (22) used to assemble the optical module (21). In this embodiment, the optical module (21) is constituted by several optical components (211) that are of the function of changing the projecting effect of LED. The said projecting effects include but not limited to projecting range, light shape and projecting angles. The module unit (22) is a framework structure that allows the equidistant arrangement of the several optical components (211). The projecting effect adjusting device (20) is posed in front of the projector (10) via the displacing control module (30) and is set at a preset distance from the emitting side (121) of the LED (12).

The displacing control module (30) includes a pair of linear tracks (31) set on the base (13) of the projector (10) and sliding part (32) that is installed on the projecting effect adjusting device (20). The sliding part (32) can move forward and backward along the linear tracks (31) and allows the two-dimensional displacement of the projecting effect adjusting device (20). The locating module (40) includes a holder unit (41) that connects to the module unit (22) and the base (13) of the projector (10), a moving unit (42) and a tightening unit (43) that allows a fixed installation of the moving unit (42) on the holder unit (41). The locating module (40) allows the projecting effect adjusting device (20) to be located at a preset position.

As shown in FIG. 3 and FIG. 4, the displacing control module (30) allows the two-dimensional displacement and fixed-point locating of the projecting effect adjusting device (20). The two-dimensional plane is parallel to the light-emitting plane (121) of the LED (12). The displacement on the two-dimensional plane means displacement only on X axle, only on Y axle or both on X and Y axles. In this embodiment, displacement forward and backward on the Y axle is illustrated, i.e., a linear displacement on the Y axle. It is further described as follows:
The projecting effect adjusting device (20) can be displaced from the first position as shown in FIG. 3 to the second position as shown in FIG. 4 and, via the locating module (40), the projecting effect adjusting device (20) can be fixed on the first and second positions. The first position is set to keep a distance between the optical module (21) of the projecting effect adjusting device (20) and the LED matrix light source. The second position is set at the light-emitting plane opposite to the LED matrix light source that the light emitted by the LED light source penetrates the optical module (21) of the projecting effect adjusting device (20) and forms a second projecting effect which is different from the first projecting effect. The projecting effect changes according to the design of the optical module (21). In the case that the optical module (21) is designed to diffuse light, when the optical module (21) of the projecting effect adjusting device (20) is at the second position, the light shape and the projecting range is enlarged. In another case that the optical module (21) is designed to refract light, when the optical module (21) of the projecting effect adjusting device (20) is at the second position, the projecting angle of the LED matrix lighting source is changed.

As shown in FIG. 5, FIG. 6 and FIG. 7, the base (13) described above is a heat sink base with cooling fins. The heat sink base helps heat dissipation of the projector (10). The base (13) provides a space to contain the locating module (40) and a window (131) to facilitate the operation of the tightening unit (43).

While this invention has been particularly shown and described with references to preferred embodiments thereof, it will be understood by those skilled in the art that various changes in form and details may be made therein without departing from the scope of the invention encompassed by the appended claims. Any modification or change not departing from the main idea of the present invention is within the scope of the patent claimed.

### BRIEF DESCRIPTION OF THE DRAWINGS

FIG. 1 is the exploded view of the present invention.

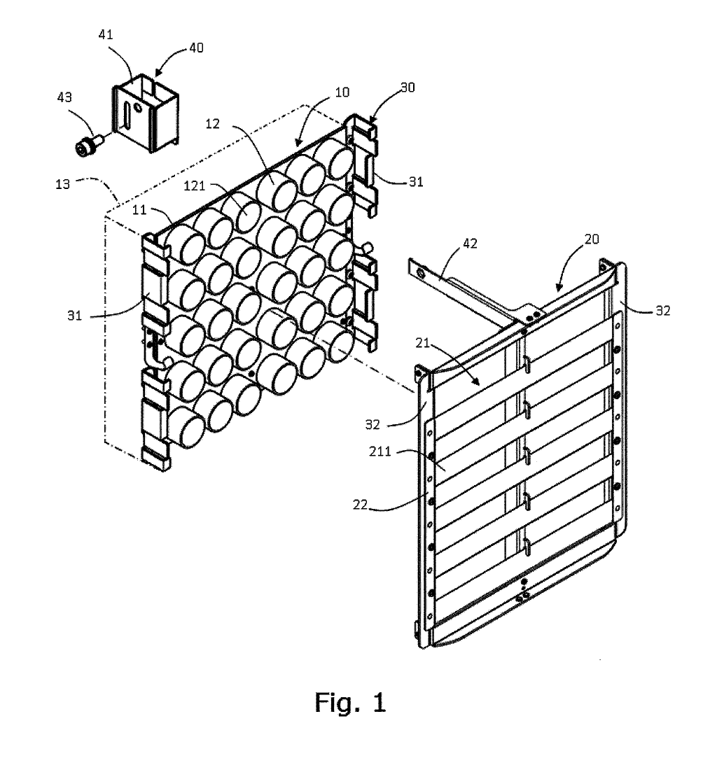

FIG. 2 is the composite external view of the present invention.

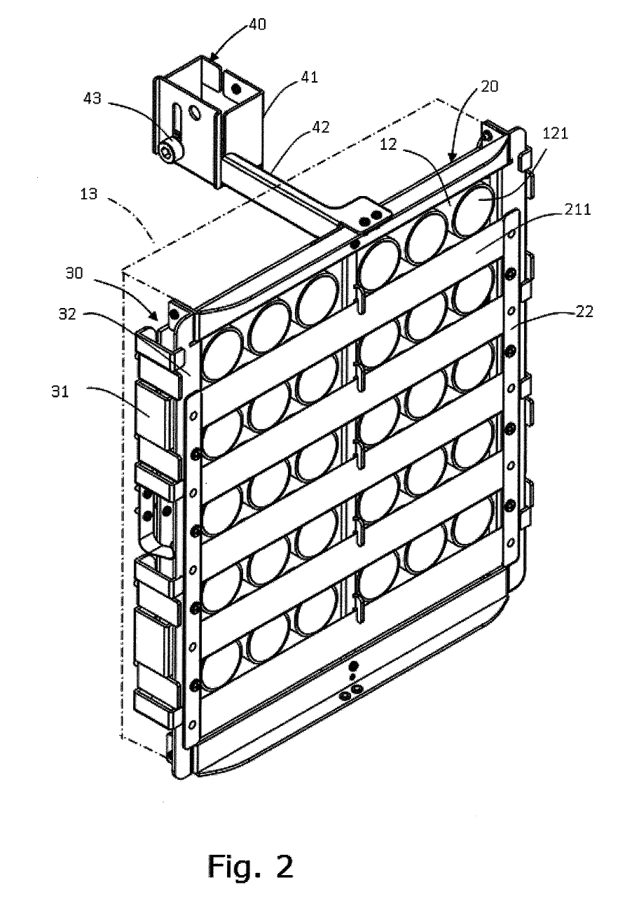

FIG. 3 is the first composite front view of the present invention.

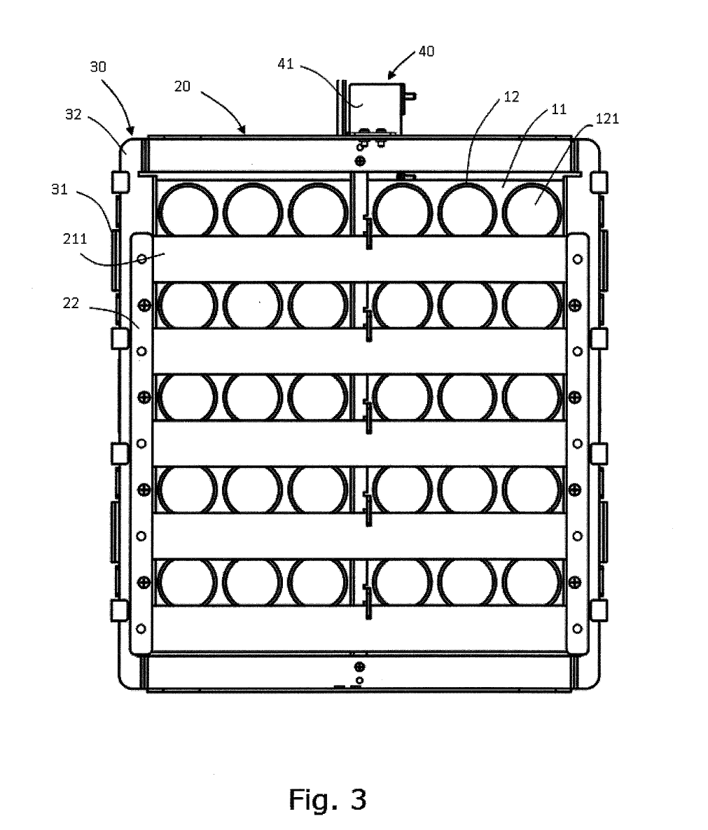

FIG. 4 is the second composite front view of the present invention.

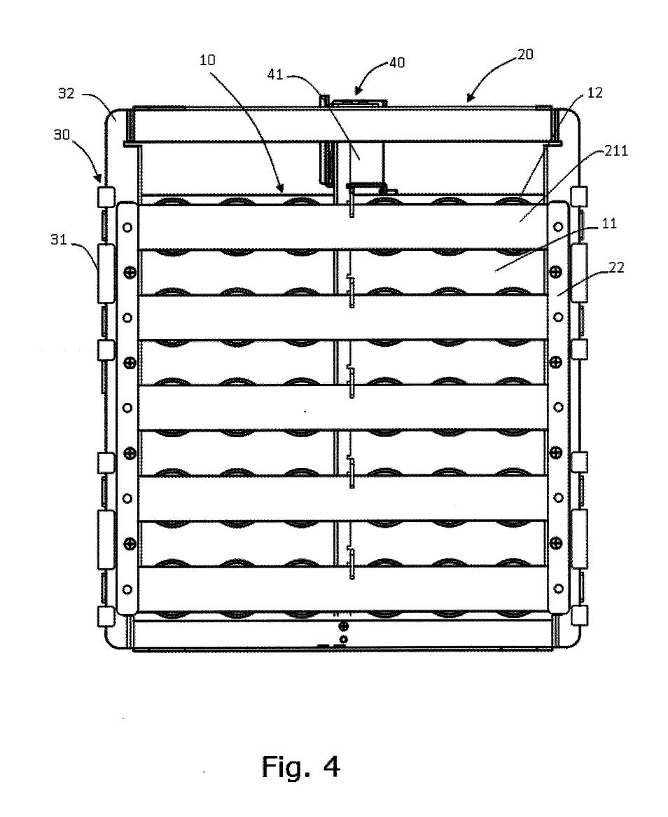

FIG. 5 is the first external view of an embodiment of the present invention installed on the heat sink base.

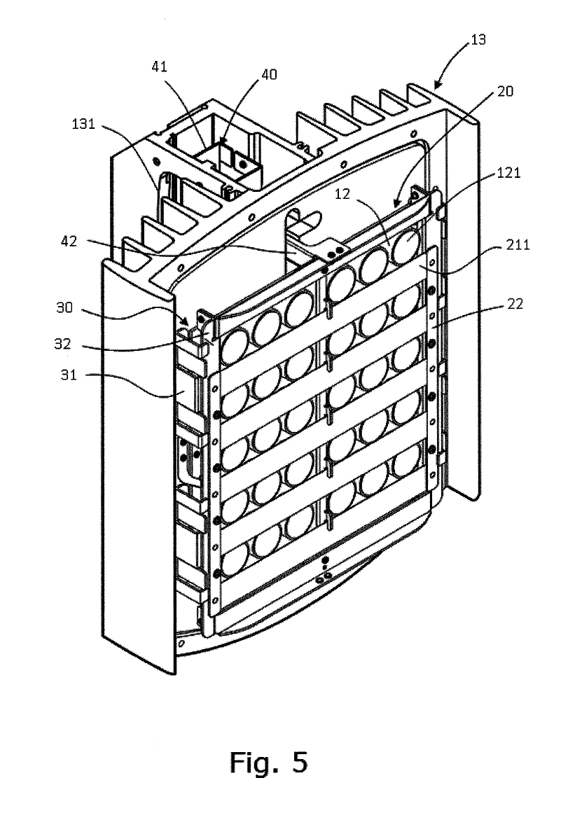

FIG. 6 is the second external view of an embodiment of the present invention installed on the heat sink base.

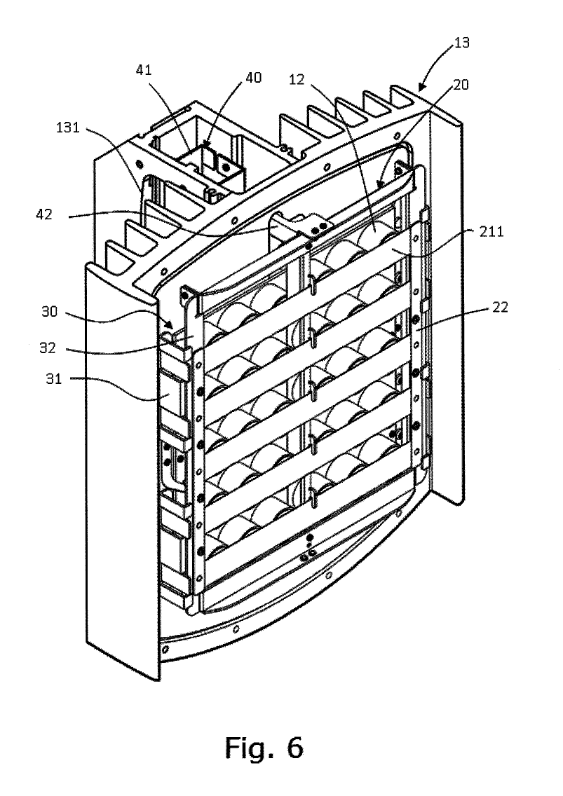

FIG. 7 is the back view of an embodiment of the present invention installed on the heat sink base.

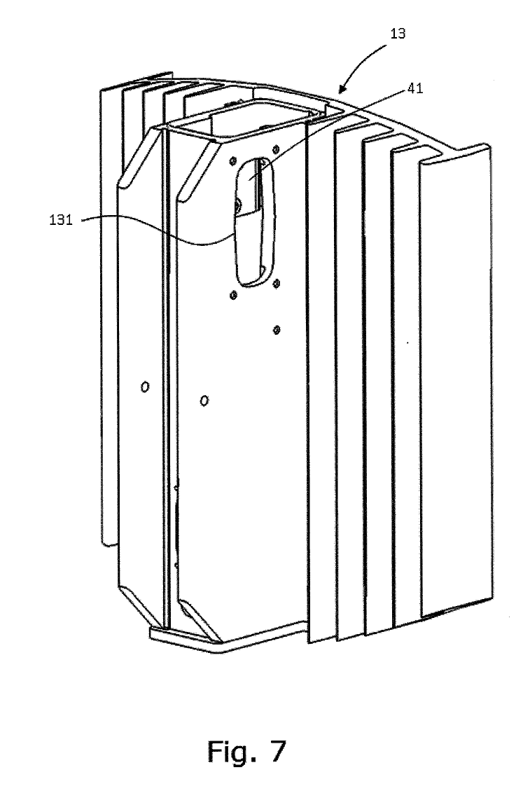

### DESCRIPTION OF MAIN COMPONENTS

10—projector
11—base plate
12—LED
121—light-emitting plate
13—base
131—window
20—projecting effect adjusting device
21—optical module
211—optical component
22—module unit
30—displacing control module
31—linear track
32—sliding part
40—locating module
41—holder unit
42—moving unit
43—tightening unit

What is claimed is:

1. A LED projector with adjustable projecting effects that includes:
a projector that contains several LED set on a base plate in a matrix arrangement;
a projecting effect adjusting device that contains a optical module;
a displacing control module on which the projecting effect adjusting device is installed in front of the projecting side of the projector, the displacing control module also allows the projecting effect adjusting device to move within a two-dimensional zone; and
a locating module set on the base of the projector that allows the projecting effect adjusting device to be fixed at a preset position in the displacement zone.

2. The LED projector with adjustable projecting effect as in claim 1, wherein the projecting effect adjusting device can move linearly, forward and backward between the first position and the second position. Also the projecting effect adjusting device can be set at a location between the first position and the second position using the locating module.

3. The LED projector with adjustable projecting effect as in claim 2, wherein the first position is set to keep a distance between the optical module and the second position is set at the light-emitting plane opposite to the LED matrix light source.

4. The LED projector with adjustable projecting effect as in claim 1, wherein the projecting effect adjusting device includes a module unit used to integrate the optical module.

5. The LED projector with adjustable projecting effect as in claim 4, wherein the optical module contains several optical components which are arranged in an equidistant manner using the module unit.

6. The LED projector with adjustable projecting effect as in claim 1, wherein the displacing control module contains a pair of linear tracks set on the base of the projector and sliding parts that are installed on the projecting effect adjusting device.

7. The LED projector with adjustable projecting effect as in claim 1, wherein the locating module contains a holder unit that connects to the projecting effect adjusting device and the base of the projector, a moving unit and a tightening unit that allows a fixed installation of the moving unit on the holder unit.

8. The LED projector with adjustable projecting effect as in claim 1, wherein the base is a heat sink base with cooling fins.
